(19) United States
(12) Patent Application Publication
(10) Pub. No.: US 2018/0030665 A1
(43) Pub. Date: Feb. 1, 2018

(54) Composite Rig Mat Comprising Pultruded Composite Members

(71) Applicant: Paul Dagesse, Beaverlodge (CA)

(72) Inventor: Paul Dagesse, Beaverlodge (CA)

(21) Appl. No.: 15/589,239

(22) Filed: May 8, 2017

Related U.S. Application Data
(60) Provisional application No. 62/367,332, filed on Jul. 27, 2016.

(51) Int. Cl. E01C 9/08; B29C 70/52

(52) U.S. Cl. CPC E01C 9/086; B29C 70/52; E01C 2201/16

(57) ABSTRACT

A composite mat comprises a plurality of layers each comprising a plurality of elongate members extending parallel to one another and transversely to the elongate members forming the adjacent layer. Thus, each member of a first layer spans across the members of a second layer such that each member of the first layer intersects each one of the members of the second layer at respective intersecting locations. Each elongate member is formed from pultruded composite material defining a tubular body which encloses a longitudinal axis of the respective member. The tubular body has on its outside an opposing pair of wide faces and an opposing pair of narrow faces. The tubular body includes an interior cavity in which there is provided a reinforcing rib bridging the cavity in a direction from one wide face to the opposite one so as to resist compression of the body in this direction.

This application claims the benefit under 35 U.S.C. 119(e) to U.S. Provisional Application Ser. No. 62/367,332 filed Jul. 27, 2016.

The present invention relates to a composite mat which is suited particularly but not exclusively for use as a temporary road mat or work area mat, particularly of the type used in oil, logging, and mining industries where such mats are known to facilitate equipment transportation or vehicle traffic in areas where permanent roads are non-existent or too expensive and where the ground is not stable enough to regularly support heavy equipment.

### SUMMARY OF THE INVENTION

According to an aspect of the invention there is provided a rig mat comprising:

a first layer comprising a plurality of elongate first members extending parallel to one another in a longitudinal direction between first and second ends of the mat;

a second layer comprising a plurality of elongate second members spanning across the first members, parallel to one another and transversely to the first members such that each second member intersects a plurality of the first members at respective intersecting locations of the mat;

a plurality of fasteners mounted at selected intersecting locations, each fastener joining one of the first members of the first layer to one of the second members of the second layer;

wherein each of the first and second members is formed by pultrusion from composite material so as to define an elongated tubular body enclosing a longitudinal axis of the respective member;

the tubular body having on its outside first and second wide faces and first and second narrow faces, each face spanning from a first end to a second end of the respective member;

the first members being arranged in the first layer and the second members being arranged in the second layer such that the wide faces of the first members in the first layer are facing the wide faces of the second members in the second layer;

each of the first and second members having a thickness of the member measured between the first and second wide faces and a width of the member measured between the first and second narrow faces;

the tubular body having an interior peripheral surface which is spaced by a thickness of the pultruded composite material from an outer peripheral surface of the tubular body collectively defined by the first and second wide faces and the first and second narrow faces, the interior peripheral surface delimiting a cavity of the tubular body which spans from a first location at or adjacent the first end of the member to a second location at or adjacent the second end of the member;

each one of the first and second members including at least one reinforcing rib extending along a length of the cavity from the first location to the second location, said at least one reinforcing rib bridging the cavity in a direction of the thickness of the member and being spaced from the interior peripheral surface in a direction of the width of the member so as to resist compression of the tubular body in the direction of the thickness of the member.

That is, each layer having a face at an outer periphery of the mat that is collectively defined by one of the first and second wide faces of the members of that layer is arranged to define a exterior support surface of the mat which engages the ground or receives thereon for example a tire of a vehicle or feet of a user. As such, weight of the vehicle or the user on the mat acts as a compressive force on the mat which would otherwise displace one of the exterior support surfaces of the mat towards the opposite one of the exterior support surfaces. The reinforcing ribs of the members forming the mat layers rigidify the mat so as to withstand compression.

In one arrangement there are a plurality of reinforcing ribs each spaced from the next in the direction of the width of the member.

Typically the tubular body is rectangular in cross-section such that the first and second wide faces of each member are planar and parallel to one another, and the first and second narrow faces of each member are planar and parallel to one another. The faces may meet at right angles at their contiguous edges, or these contiguous edges may be rounded so that the outer peripheral surface is uninterrupted around its transverse circumference.

In some arrangements there is provided a third layer comprising a plurality of elongate third members spanning across the second members, parallel to one another and transversely to the second members such that one of the third members intersects one of the second members at each intersecting location between first and second members. Like the first and second members, these third members are formed from the pultruded composite material defining the elongated tubular body. In such arrangements with the third layer, one of the fasteners joins one of the first members to one of the third members with one of the second members sandwiched therebetween at each intersecting location.

In other arrangements there may be provided additional layers each comprising a plurality of elongated members spanning across the members of the adjacent layer, parallel to one another and transversely to the members of the adjacent layer, so that the number of layers is more than three.

In some arrangements the first and second ends of the respective member are open. In some arrangements the first end and the second end of the respective member are closed so that the cavity of the respective member is enclosed.

In one arrangement the first and second ends of the respective member are open and the cavity spans the full length of the respective member.

In such arrangements said at least one reinforcing rib typically spans the full length of the respective member.

Each fastener at the respective intersecting location may pass through one of the members of each layer at a spaced location from said at least one reinforcing rib thereof.

For example, the thickness of the respective member lies in a range between 1″ and 2.25″ and the width of the respective member lies in a range between 6″ and 10″.

The mat preferably includes a connecting arrangement so that it is connectable to another such mat and whereby a series of the mats may be connected together. In one arrangement of the mat having the connecting arrangement, selected members of an outer layer of the mat are arranged to project beyond one of the first and second ends of the mat so as to form fingers for interconnecting at corresponding gaps of another mat which are formed at locations of the selected members where an opposite end of the respective selected members is spaced longitudinally inwardly from the end of the mat.

### BRIEF DESCRIPTION OF THE DRAWINGS

One embodiment of the invention will now be described in conjunction with the accompanying drawings in which:

FIG. 1 is a perspective view of mat according to the present invention.

FIG. 2 is a top plan view of the mat of FIG. 1 where some reinforcing ribs are schematically illustrated.

FIG. 3 is a cross-sectional view of a portion of the mat of FIG. 1 near one mat end, where some members of a middle layer are shown with a different number of reinforcing ribs.

In the drawings like characters of reference indicate corresponding parts in the different figures.

### DETAILED DESCRIPTION

There is illustrated in the accompanying figures a composite mat 10 which is particularly but not exclusively suited for use in oil, logging, and mining industries for forming a temporary work surface or road surface in areas where the ground is otherwise unstable or unsuitable for supporting thereon a permanent work or road surface. These types of mats may be considered to fall within the category of ‘rig mats’ which may be more broadly regarded as portable platforms.

In the illustrated embodiment the composite mat 10 comprises three layers respectively indicated at 13, 14, and 15. Each of the layers is formed by composite members 17 arranged in a common plane where the members 17 of the respective layer are oriented perpendicularly transverse to the members of the adjacent layer. The mat of the illustrated arrangement is generally rectangular in shape (in plan view) as is common of commercially available rig mats.

More specifically, there is provided a first bottom layer 13 comprising a plurality of composite members 17 which are arranged parallel to one another in a respective common plane with at least one of the exterior narrow faces 19, 20 which are on opposite sides of the respective member facing that of the adjacent composite member of the first layer 13. As such, broad or wide exterior faces 21 and 22 of the respective member are positioned so as to face normally to the plane defined by the layer 17.

The composite members 17 of the first layer 13 thus extend in a longitudinal direction of the mat 10 between a first mat end 25 and a second mat end 26. Further, the members 17 of the first bottom layer 13 each are arranged in close proximity to the next of the first layer so that a gap between adjacent members 17 is considerably smaller than a width WM of the individual composite member which is measured from the first narrow face 19 to the second narrow face 20. A thickness TM of the respective composite member 17 is measured between the first and second wide faces 21, 22.

The composite mat 10 has a second middle layer 14 on top of the first bottom layer 13. The second middle layer 14 comprises a plurality of the composite members 17 arranged in a respective common plane spanning across the composite members forming the first layer 13 such that each member 17 of the second layer 14 intersects a plurality of the first layer's members at respective intersecting locations IL of the mat. The composite members 17 of the second layer 14 are again oriented parallel to one another and lie in close proximity to one another to define a small gap between adjacent composite members. More specifically, the members forming the second layer 14 are oriented perpendicular to the members of the first layer 13 so as to be perpendicular to the longitudinal direction and to extend in a perpendicularly transverse direction between opposite sides 27, 28 of the mat. Further, the composite members of the second layer are arranged with their wide faces 21 facing the wide faces 22 of the first layer such that the members of adjacent layers are positioned with their wide faces in abutment with one another.

By the orientation of the composite members, the intersecting locations IL are arranged in transversely extending rows in which each transverse row of intersecting locations corresponds to the intersecting locations of one of the second layer members of the middle layer 14 extending in the perpendicularly transverse direction between the sides 27 and 28 of the mat. Plural transverse rows of intersecting locations IL are thus defined, each corresponding to one of the composite members 17 of the middle layer 14 so that the lateral rows are spaced in the longitudinal direction from one another between the first and second ends 25, 26 of the mat.

Furthermore, the composite mat 10 includes a third top layer 15 of the composite members 17 arranged on top of the second middle layer 14 so as to be opposite the first bottom layer 13. The composite members of the third layer 15 again are arranged in a respective common plane spanning across the composite members 17 of the second layer 14 and each in close proximity to the next of the third layer 15 such that there is defined a small gap between adjacent composite members of the third layer. Further, the composite members 17 extend parallel to one another and transversely to the composite members of the second layer such that one of the composite members of the third layer intersects one of the second layer's members at each intersecting location IL formed between the members 17 of the first and second layer 13, 14. The composite members forming the third layer 15 thus extend in the longitudinal direction and are aligned normally of the plane with corresponding ones of the members of the first bottom layer 13. As such, each third layer member overlaps each intersection location IL formed between the first and second layers 13, 14.

The three layer 13, 14, and 15 are held together by fasteners 30, for example rivet fasteners, in a conventional manner known in the art of rig mats. Each fastener 30 is positioned at one of the intersecting locations IL and passes through each one of the layers so as to compressively join together same. As such, the members of the second layer 14 are sandwiched between the composite members of the first bottom layer 13 and the third top layer 15 at each intersecting location.

Each composite member 17 forming the mat layers 13 through 15 is made by pultrusion from composite material so as to define a tubular body 32. The tubular body 32 is elongated along a longitudinal axis of the composite member enclosed by the tubular body. The body may also be regarded as a tubular wall of the composite member.

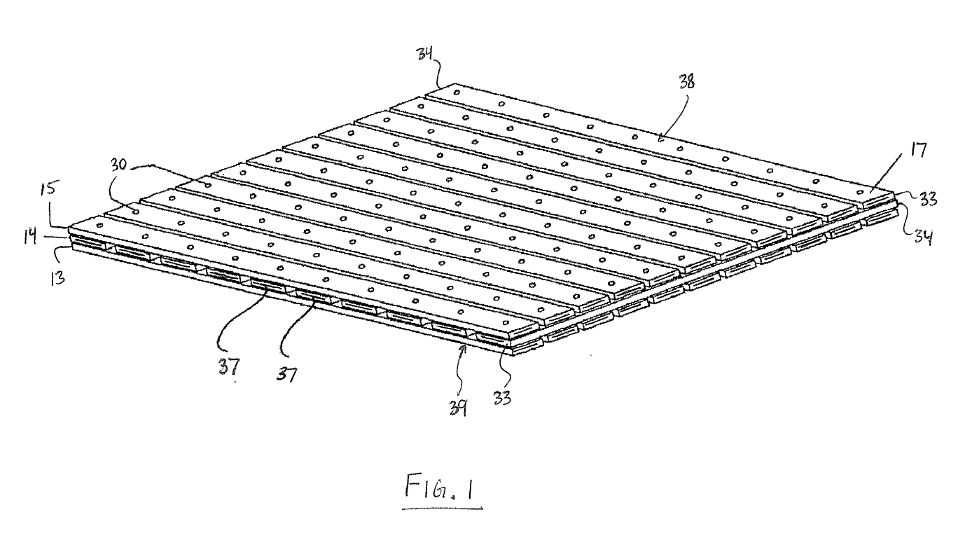

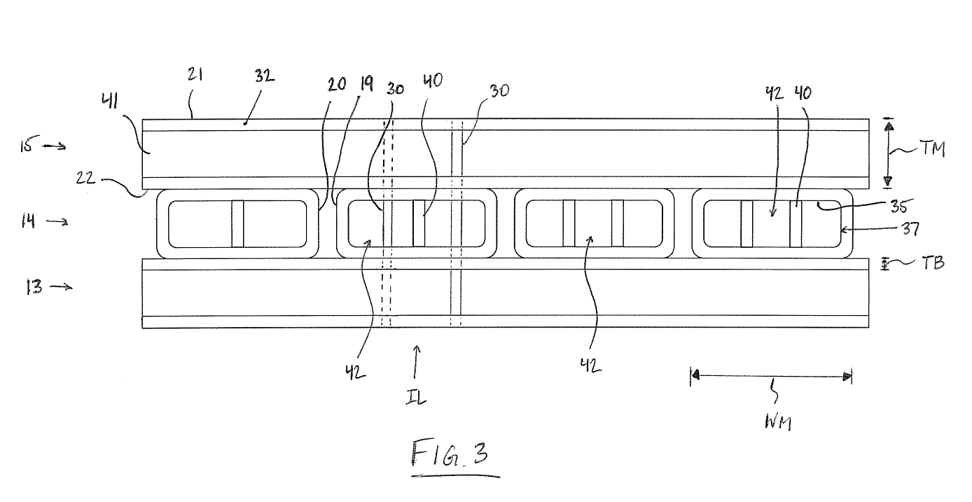

The tubular body 32 of the illustrated embodiment has rectangular cross section such that the first and second wide faces 21, 22 of each member are planar and parallel to one another, and the first and second narrow faces 19, 20 of each member are planar and parallel to one another. As most clearly shown in FIG. 3 but not in FIG. 1 for convenience of illustration, contiguous edges of adjacent faces, for example each pair of one of the wide faces 21 or 22 and one of the narrow faces 19 and 20, are rounded so that an outer peripheral surface of the respective member that is collectively defined by the narrow faces 19 and 20 and the wide faces 21 and 22 on the outside of the tubular body 32 is uninterrupted around its transverse circumference.

As mentioned earlier, each tubular body 32 is elongated in a longitudinal direction of the respective composite member from a first member end 33 to a second member end 34. Each one of the narrow faces 19 and 20 and the wide faces 21 and 22 spans from the first to second member ends 33, 34.

The tubular body of each composite member includes an interior peripheral surface 35 which is spaced by a thickness TB of the pultruded composite material from the outer peripheral surface and thus delimits a cavity 37 of the body. It will be appreciated that the material thickness of the body may vary at different locations about a periphery of the body such that the thickness of the composite material for example may be smaller between the interior peripheral surface 35 at one of the wide faces 21 or 22 than between the interior peripheral surface 35 at one of the narrow faces 19 or 20. The cavity 37 spans from a first end location at or adjacent the first member end 33 to a second end location at or adjacent the second member end 34. In the illustrated arrangement, the tubular body 32 is open at the first and second member ends 33, 34, and the first and second end locations of the cavity are at the first and second member ends and thus correspond thereto, as shown schematically in FIG. 1.

It will be appreciated that each layer having a face at an outer periphery of the mat that is collectively defined by one of the first and second wide faces of the members of that layer is arranged to define a exterior support surface 38, 39 of the mat which engages the ground or receives thereon for example a tire of a vehicle, heavy equipment, or feet of a user. In the illustrated embodiment, the first bottom layer 13 defines one of the exterior surfaces 39 at its bottom and the third top layer 15 defines one of the exterior surfaces 38 at its top.

Further, persons skilled in the art of rig mats understand that these mats undergo substantial compressive forces which would otherwise act to displace one of the exterior support surfaces of the mat towards the opposite one of the exterior support surfaces.

Pultruded composite material inherently has good tensile strength because its constituent fibers are oriented longitudinally of the axis of the composite member; however the structure of pultruded composite material is not particularly suited to withstand the compressive forces which rig mats are typically subject to.

To reinforce the tubular body 32 in order to better withstand compression acting in a direction of the thickness TM of the member, each composite member 17 includes at least one reinforcing rib 40 extending along a full length of the cavity 37 from the first end location to the second end location, that is in the illustrated embodiment from the first to second member ends 33, 34. The reinforcing rib 40 comprises an elongated sheet of pultruded composite material which bridges the cavity 37 in a direction of the thickness TM of the composite member 17 so as to resist compression of the tubular body in the direction of the thickness of the member as compressive forces acting on the respective member are typically substantially normal to the wide faces 21, 22 of the respective composite member. The rib 40 has a thickness of the order of that of the tubular body 32.

Furthermore, the reinforcing rib 40 is spaced from the interior peripheral 35 surface in a direction of the width WM of the respective composite member. As such, the reinforcing rib forms a cell 42 within the cavity 37 to either side thereof in the width direction of the composite member. The respective cell 42 is defined by a face of each reinforcing rib bordering the cell and a portion of the interior peripheral surface 35. As such, each cell 42 is an elongate sub-compartment of the respective cavity 37.

Typically, the fasteners 30 are arranged at the intersecting locations IL to pass through each layer of composite members generally centrally through one of the cells 42 of each composite member so as to extend through to the respective member 17 to the side of the reinforcing rib(s) at a spaced location therefrom so as to clear of same. This is best shown in FIG. 3 where a pair of fasteners 30 are shown passing through the layers 13 through 15 for illustrative purposes at only one of the intersecting locations IL.

FIG. 3 shows tubular composite members of the second layer 14 having different numbers of reinforcing ribs. In an arrangement having more than one reinforcing rib, each rib 40 is spaced from the next in the direction of the width WM of the composite member thus forming three or more cells 42.

It will be appreciated that with the cavity 37 spanning the full length of the respective member 17, edges of the respective reinforcing rib 40 are flush with a peripheral rim at each of the first and second member ends 33, 34. Further, it will be appreciated the tubular body 32 and reinforcing rib(s) 40 are formed unitarily during manufacturing of the composite member 17, that is during the pultrusion process.

Each composite member 17 of the composite mat 10 may have example dimensions as follows:
Thickness TM of 1″ and width WM of 6″;
Thickness TM of 2.25″ and width WM of 10″.
   Thus, the thickness TM of the respective member 17 may lie in a range between 1″ and 2.25″ and a width WM lying in a range between 6″ and 10″.

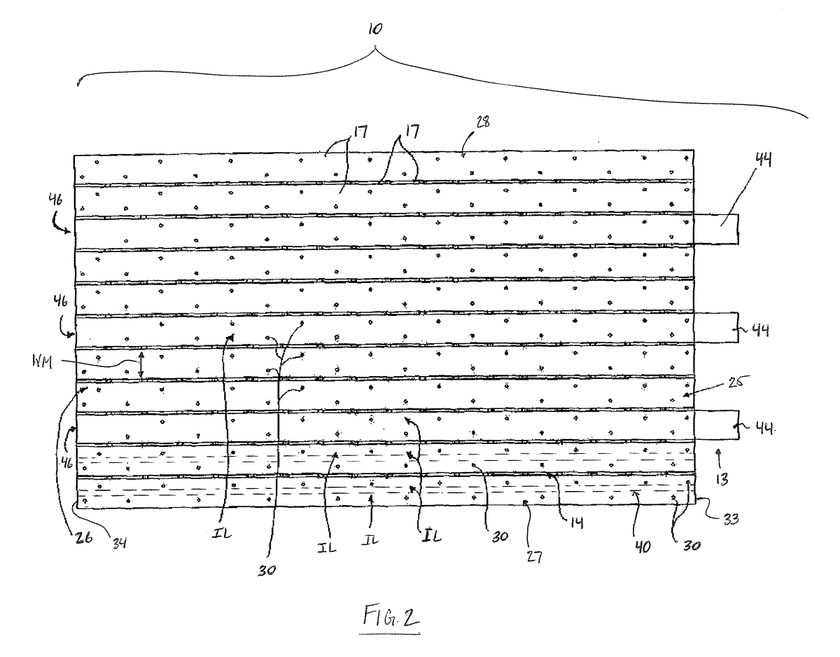

Additionally, typically each mat 10 includes a connecting arrangement so that it is connectable to another such mat and whereby a series of the mats may be connected together by cooperating male and female components on each mat. In the illustrated embodiment as shown in FIG. 2 and not in FIG. 1 for convenience of illustration, the connecting arrangement comprises a series of fingers 44 located at evenly spaced transverse positions at the first end 25 of the mat. The fingers 44 are formed by arranging selected ones of the composite members 17 of the first bottom layer 13 to project beyond the first mat end 25. As these selected members 17 are offset longitudinally in a longitudinal direction of the second mat end 26 from ends 34 of adjacent members 17 of the first layer 13, gaps are defined at the second mat end as each end of the respective selected composite member is spaced longitudinally inwardly of the second mat end 26. As such, finger-receptacles 46 are delimited by one narrow face of each of the adjacent members of the first layer and by the inwardly spaced member end of the respective selected composite member. In this manner cooperating male and female components are formed for connecting adjacent mats together.

Thus, two or more mats 10 are linkable together in a string of the mats by inserting the fingers 42 of a first mat into the receptacles 46 of a second adjacent mat.

Since various modifications can be made in my invention as herein above described, and many apparently widely different embodiments of same made, it is intended that all matter contained in the accompanying specification shall be interpreted as illustrative only and not in a limiting sense.

1. A rig mat comprising:
a first layer comprising a plurality of elongate first members extending parallel to one another in a longitudinal direction between first and second ends of the mat;
a second layer comprising a plurality of elongate second members spanning across the first members, parallel to one another and transversely to the first members such that each second member intersects a plurality of the first members at respective intersecting locations of the mat;
a plurality of fasteners mounted at selected intersecting locations, each fastener joining one of the first members of the first layer to one of the second members of the second layer;
wherein each of the first and second members is formed by pultrusion from composite material so as to define an elongated tubular body enclosing a longitudinal axis of the respective member;
the tubular body having on its outside first and second wide faces and first and second narrow faces, each face spanning from a first end to a second end of the respective member;
the first members being arranged in the first layer and the second members being arranged in the second layer such that the wide faces of the first members in the first layer are facing the wide faces of the second members in the second layer;
each of the first and second members having a thickness of the member measured between the first and second wide faces and a width of the member measured between the first and second narrow faces;
the tubular body having an interior peripheral surface which is spaced by a thickness of the pultruded composite material from an outer peripheral surface of the tubular body collectively defined by the first and second wide faces and the first and second narrow faces, the interior peripheral surface delimiting a cavity of the tubular body which spans from a first location at or adjacent the first end of the member to a second location at or adjacent the second end of the member;
each one of the first and second members including at least one reinforcing rib extending along a length of the cavity from the first location to the second location, said at least one reinforcing rib bridging the cavity in a direction of the thickness of the member and being spaced from the interior peripheral surface in a direction of the width of the member so as to resist compression of the tubular body in the direction of the thickness of the member.

2. The rig mat according to claim 1 wherein there are a plurality of reinforcing ribs each spaced from the next in the direction of the width of the member.

3. The rig mat according to claim 1 wherein the first and second ends of the respective member are open and the cavity spans the full length of the respective member.

4. The rig mat according to claim 1 wherein said at least one reinforcing rib spans the full length of the respective member.

5. The rig mat according to claim 1 wherein the each fastener at the respective intersecting location passes through one of the members of each layer at a spaced location from said at least one reinforcing rib thereof.

6. The rig mat according to claim 1 wherein there is provided a third layer comprising a plurality of elongate third members spanning across the second members, parallel to one another and transversely to the second members such that one of the third members intersects one of the second members at each intersecting location between first and second members such that one of the fasteners joins one of the first members to one of the third members with one of the second members sandwiched therebetween at each intersecting location.

7. The rig mat according to claim 1 wherein the thickness of the respective member lies in a range between 1″ and 2.25″ and the width of the respective member lies in a range between 6″ and 10″.
